(19) United States
(12) Patent Application Publication
(10) Pub. No.: US 2013/0132297 A1
(43) Pub. Date: May 23, 2013

(54) CONNECTING BUSINESS CONTEXT TO BUSINESS SOLUTION

(71) Applicant: Wolfgang Peter, Bruchsal (DE)

(72) Inventor: Wolfgang Peter, Bruchsal (DE)

(73) Assignee: SAP AG, Walldorf (DE)

(21) Appl. No.: 13/303,662

(22) Filed: Nov. 23, 2011

(51) Int. Cl. G06Q 10/00

(52) U.S. Cl. 705/342

(57) ABSTRACT

A business management machine within a business management system may access a business model and a solution model, and the business management machine may generate a connection map based on the business model and the solution model. The business management machine may detect a business activity. Based on the detecting of the business activity, the business management machine may initiate an access of a connection map that indicates a correspondence between a business solution within the solution model and the one or more context descriptors within the business model that define the business context. The business management machine may perform the access of the connection map. Based on the access of the connection map, the detecting of the business activity, or both, the business management machine may present a reference to the business solution or to a document pertinent to the business solution or to the business context.

### TECHNICAL FIELD

The subject matter disclosed herein generally relates to the processing of data. Specifically, the present disclosure addresses systems and methods of connecting a business context to a business solution.

### BACKGROUND

Business management software may be implemented (e.g., executed) by one or more machines within a business management system. A user of the business management system may use all or part of the business management software to facilitate (e.g., perform) one or more business activities (e.g., business functions or transactions) related to the operation of a business (e.g., a company or corporation of which the user is an employee or an owner). For example, the business management software may support business activities in areas such as accounting, sales, inventory control, purchasing, shipping, receiving, customer relationship management, customer service, billing, management, marketing, or any suitable combination thereof.

### BRIEF DESCRIPTION OF THE DRAWINGS

Some embodiments are illustrated by way of example and not limitation in the figures of the accompanying drawings.

FIG. 1 is a conceptual diagram illustrating a business model represented as a data structure of context descriptors, according to some example embodiments.

FIG. 2-4 are conceptual diagrams illustrating business contexts within the business model, according to some example embodiments.

FIG. 5 is a conceptual diagram illustrating a solution model represented as a data structure of solution descriptors, according to some example embodiments.

FIG. 6 is a conceptual diagram illustrating a connection map represented as a data structure of correspondences between documents and context descriptors of the business model, according to some example embodiments.

FIG. 7 is a conceptual diagram illustrating a context log represented as a data structure storing counts of business activities correlated with business contexts, according to some example embodiments.

FIG. 8 is a network diagram illustrating a network environment suitable for connecting a business context to a business solution, according to some example embodiments.

FIG. 9 is a block diagram illustrating components of a business management machine, according to some example embodiments.

FIG. 10-11 are flowcharts illustrating operations of the business management machine in performing a method of connecting a business context to a business solution, according to some example embodiments.

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems are directed to connecting a business context to a business solution. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A user of a business management system (e.g., one or more business management machines) may be engaged in a business activity supported by the business management system. The business activity may be correlated with a business context, and the business context may be defined by one or more context descriptors within a business model (e.g., a first data structure of context descriptors). Similarly, a business solution that is pertinent to the business activity may be defined by one or more solution descriptors within a solution model (e.g., a second data structure of solution descriptors). The business management system may facilitate (e.g., process or perform) all or part of the business activity (e.g., by implementing one or more software modules configured to process or perform all or part of the business activity). Moreover, the business management system may suggest or recommend a business solution (e.g., instructions for successfully engaging, processing, or performing the business activity) that corresponds to the business activity. Furthermore, the business management system may provide information (e.g., a document or a reference to a document) that is pertinent to the business context, the business activity, the business solution, or any suitable combination thereof.

A business management machine within the business management system may detect the business activity (e.g., by monitoring activities of the user within the business management system). Based on (e.g., in response to) the detecting of the business activity, the business management machine may initiate an access of a connection map (e.g., a third data structure) that indicates a correspondence between the business solution and the business activity (e.g., between the one or more solution descriptors and the one or more context descriptors). In some example embodiments, the business management machine performs the access of the connection map (e.g., from a database). Based on the access of the connection map, the detecting of the business activity, or both, the business management machine may present a reference to the business solution or a reference to a document (e.g., a title, description, or link) that is pertinent to the business solution, the business context, the business activity, or any suitable combination thereof. The reference (e.g., to the document) may be presented to a device of the user (e.g., a client device with respect to the business management system).

According to some example embodiments, the business management machine generates the connection map. The business management machine may access the business model (e.g., the first data structure), in which a portion (e.g., a first portion) of the context descriptors in the business model define (e.g., indicate) the business context of the business activity (e.g., among multiple business contexts within the business model). Similarly, the business management machine may access the solution model (e.g., the second data structure), in which a portion (e.g., a second portion of the solution descriptors in the solution model define the business solution. Based on (e.g., in response to) the accessing of the business model, the solution model, or both, the business management machine may generate the connection map (e.g., the third data structure), where the connection map indicates the correspondence between the portion of the solution descriptors that define the business solution and the portion of the context descriptors that define the business context of the business activity.

According to certain example embodiments, the business management machine presents another reference (e.g., a further reference) to another business solution (e.g., a further business solution) or another document (e.g., a further document) in a dynamic or context-sensitive manner by detecting another business activity (e.g., a further business activity) engaged in by the user. This new business activity may be correlated with another business context (e.g., a further business context) defined in the business model. Based on (e.g., in response to) the detecting of the new business activity, the business management machine may present the new reference to the device of the user. For example, the business management machine may present the new reference by replacing the previous reference with the new reference to the new document within a graphical window (e.g., of a user interface). Such a graphical window may be presented to the user (e.g., via the device of the user).

According to various example embodiments, the business management machine receives a user-generated request (e.g., a mouse click on a reference to a document) for presentation of a document that corresponds to the business solution, the business context, the business activity, or any suitable combination thereof. Based on (e.g., in response to) this user-generated request, the business management machine may present (e.g., provide, display, or communicate) the document to the user (e.g., via the device to the user).

In some example embodiments, the business management machine tracks business activities, their corresponding business contexts, or both, by updating a context log (e.g., a fourth data structure) that stores one or more counts of business activities (e.g., along with their corresponding business contexts). The updating of the context log may be based on the detecting of the business activity engaged by the user and correlated with the business context defined (e.g., indicated) by the portion of the context descriptors in the business model.

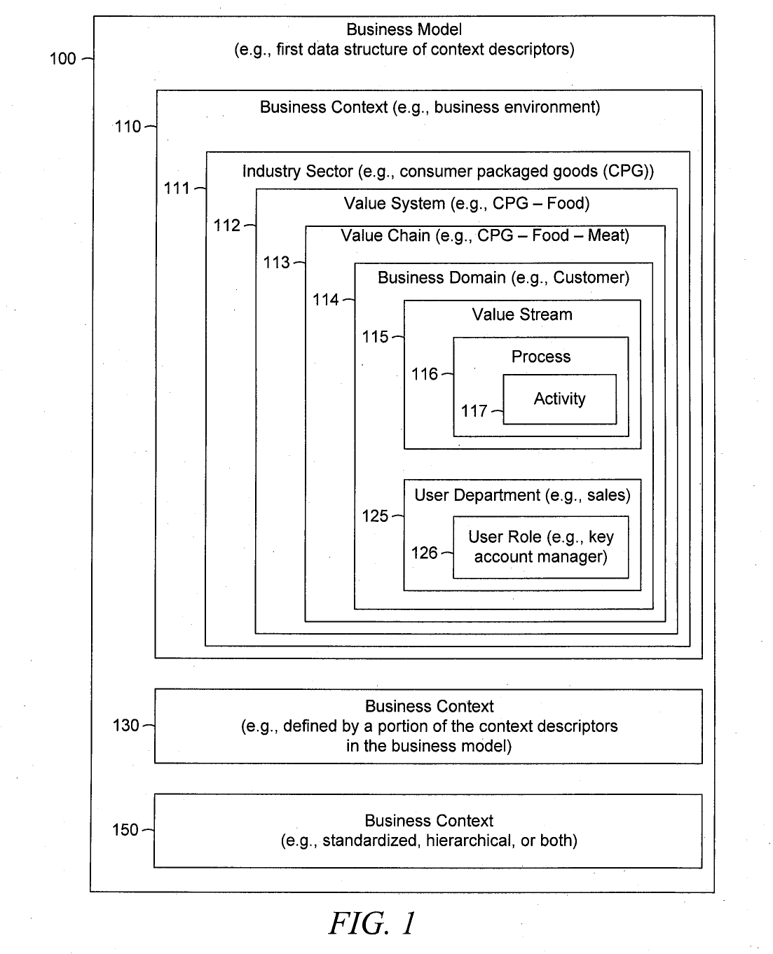

FIG. 1 is a conceptual diagram illustrating a business model 100, which is represented as a data structure (e.g., a first data structure) of context descriptors (e.g., context descriptors 111-126), according to some example embodiments. As shown, the business model 100 includes multiple business contexts 110, 130, and 150. Each of the business contexts 110, 130, and 150 may be defined (e.g., indicated) within the business model 100 by one or more context descriptors (e.g., a word, phrase, string, number, or code that describes an aspect, a characteristic, or an attribute of an activity or its business context). Accordingly, one or more of the business contexts 110, 130, and 150 may be defined by a portion (e.g., a first portion) of the context descriptors in the business model 100 (e.g., a subset of the context descriptors in the business model 100).

Moreover, one or more of the business contexts 110, 130, and 150 may be standardized (e.g., conforming to or compliant with an industry standard), hierarchical (e.g., arranged as a hierarchy of context descriptors), or both. In various example embodiments, the business model 100 is standardized, hierarchical, or both. In some example embodiments, the context descriptors are arranged as multiple branches of the business model 100, where each business context is defined by one of the multiple branches, and each of the multiple branches is defined by a portion (e.g., a unique subset) of the context descriptors in the business model 100.

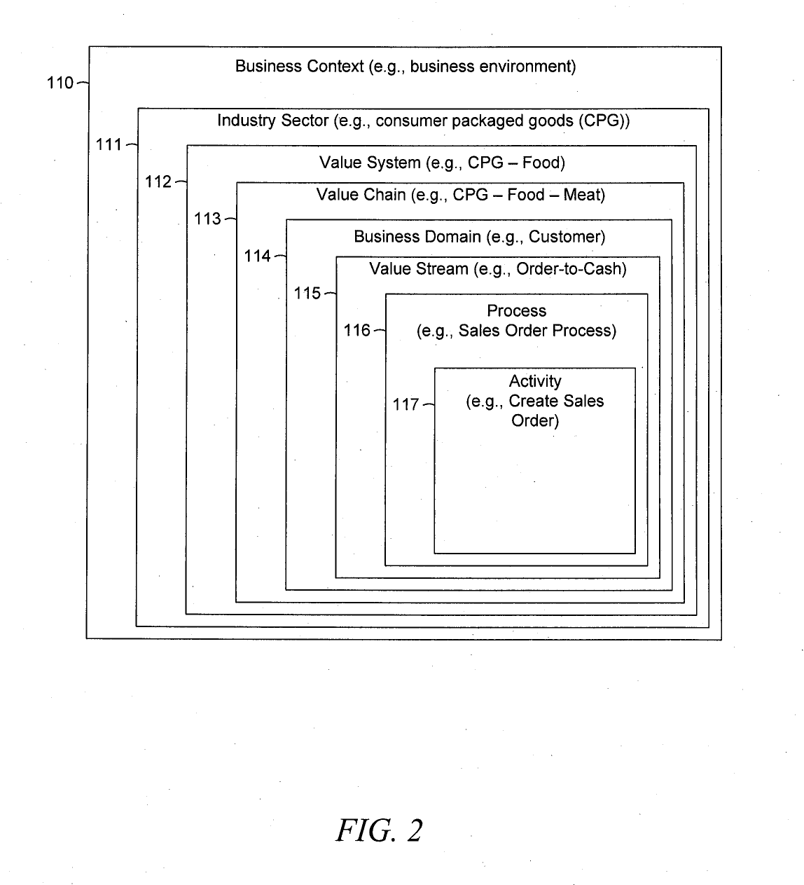

The business context 110 may include the context descriptors 111-126 which define (e.g., indicate) the business context 110 within the business model 100. In other words, the business context 110 may be defined (e.g., in its entirety) by the context descriptors 111-126. In some example embodiments, the business context 110 is defined by the context descriptors 111-117, while in certain example embodiments, the business context 110 is defined by the context descriptors 111-126. The context descriptors 111-126 may be arranged (e.g., represented) hierarchically as shown in FIG. 1 and FIG. 2.

The context descriptor 111 may represent an industry sector (e.g., “consumer packaged goods (CPG)”) and may be arranged as being superior to (e.g., inclusive of or more general than) the context descriptor 112. The context descriptor 112 may represent a value system (e.g., “CPG-Food”) and may be arranged as being superior to the context descriptor 113. The context descriptor 113 may represent a value chain (e.g., “CPG-Food-Meat” or “CPG-Food-Dairy”) and may be arranged as being superior to the context descriptor 114. The context descriptor 114 may represent a business domain (e.g., “Customer”) and may be arranged as being superior to the context descriptors 115 and 125.

As shown in FIG. 2, the context descriptor 115 may represent a value stream (e.g., “Order-to-Cash”) and may be arranged as being superior to the context descriptor 116. The context descriptor 116 may represent a process (e.g., “Sales Order Process”) and may be arranged as being superior to the context descriptor 117. The process represented by the context descriptor 116 may be a business process with respect to the business model 100. The context descriptor 117 may represent an activity (e.g., “Create Sales Order”). The activity represented by the context descriptor 117 may be a business activity (e.g., a business function or business transaction) with respect to the business model 100.

As shown in FIG. 1, the context descriptor 125 may represent a user department (e.g., “Sales”) and may be arranged as being superior to the context descriptor 126. The context descriptor 126 may represent a user role (e.g., “Key Account Manager”). Accordingly, the business context 110 may be defined (e.g., indicated) by the context descriptors 111-126 (e.g., as a creation of a sales order by a key account manager) within the business model 100 for use within a business management machine or system.

FIG. 2-4 are conceptual diagrams illustrating business contexts within the business model, according to some example embodiments. As shown in FIG. 2, some example embodiments of the business context 110 need not define or indicate a user department or user role (e.g., by inclusion of the context descriptors 125 and 126).

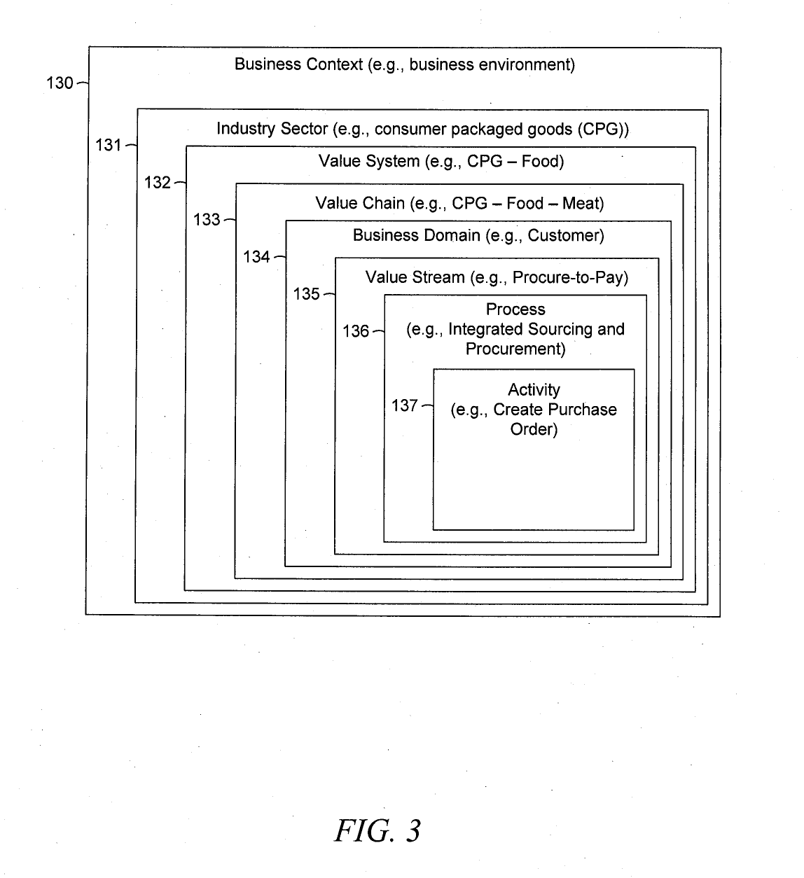

As shown in FIG. 3, the business context 130 includes the context descriptors 131-137. The context descriptor 131 may represent an industry sector (e.g., “consumer packaged goods (CPG)”) and may be arranged as being superior to the context descriptor 132. The context descriptor 132 may represent a value system (e.g., “CPG-Food”) and may be arranged as being superior to the context descriptor 133. The context descriptor 133 may represent a value chain (e.g., “CPG-Food-Meat”or “CPG-Food-Dairy”) and may be arranged as being superior to the context descriptor 134. The context descriptor 134 may represent a business domain (e.g., “Customer”) and may be arranged as being superior to the context descriptor 135. The context descriptor 135 may represent a value stream (e.g., “Procure-to-Pay”) and may be arranged as being superior to the context descriptor 136. The context descriptor 136 may represent a process (e.g., “Integrated Sourcing and Procurement”) and may be arranged as being superior to the context descriptor 137. The process represented by the context descriptor 136 may be a business process with respect to the business model 100. The context descriptor 137 may represent an activity (e.g., “Create Purchase Order”). The activity represented by the context descriptor 137 may be a business activity with respect to the business model 100.

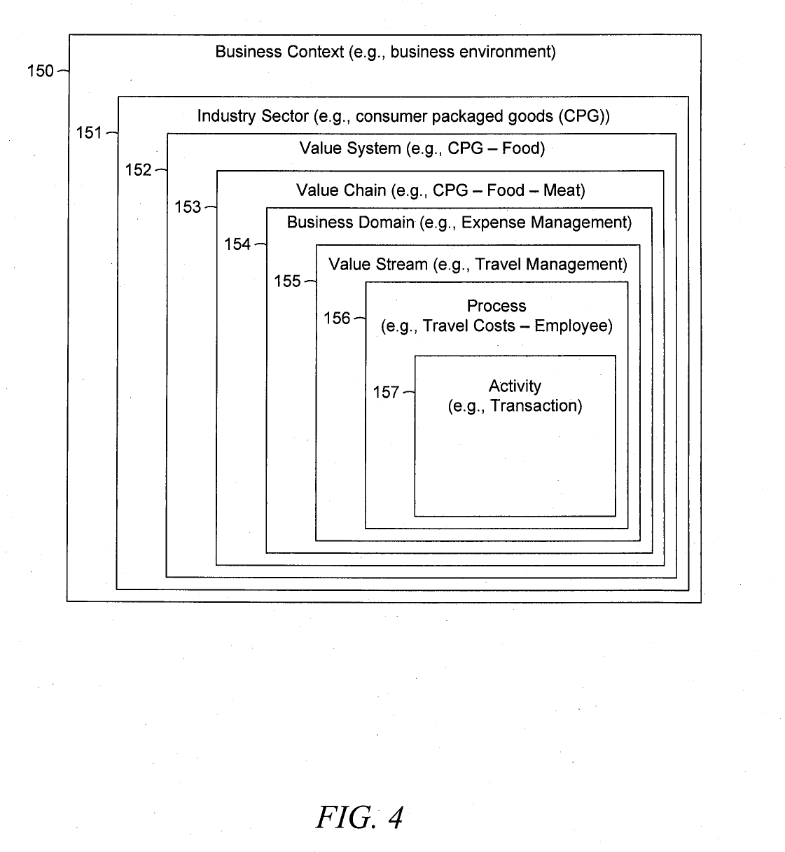

As shown in FIG. 4, the business context 150 includes the context descriptors 151-157. The context descriptor 151 may represent an industry sector (e.g., “consumer packaged goods (CPG)”) and may be arranged as being superior to the context descriptor 152. The context descriptor 152 may represent a value system (e.g., “CPG-Food”) and may be arranged as being superior to the context descriptor 153. The context descriptor 153 may represent a value chain (e.g., “CPG-Food-Meat” or “CPG-Food-Dairy”) and may be arranged as being superior to the context descriptor 154. The context descriptor 154 may represent a business domain (e.g., “Expense Management”) and may be arranged as being superior to the context descriptor 155. The context descriptor 155 may represent a value stream (e.g., “Travel Management”) and may be arranged as being superior to the context descriptor 156. The context descriptor 156 may represent a process (e.g., “Travel Costs-Employee”) and may be arranged as being superior to the context descriptor 157. The process represented by the context descriptor 156 may be a business process with respect to the business model 100. The context descriptor 157 may represent an activity (e.g., “Transaction”). The activity represented by the context descriptor 157 may be a business activity with respect to the business model 100.

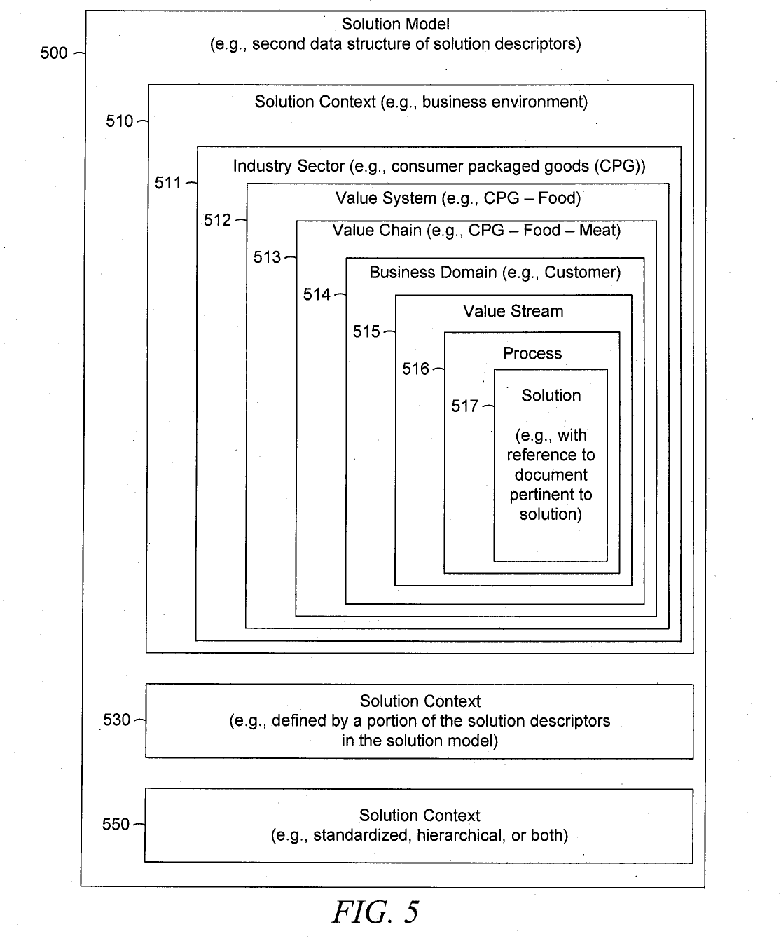

FIG. 5 is a conceptual diagram illustrating a solution model represented as a data structure (e.g., a second data structure) of solution descriptors, according to some example embodiments. As shown, the solution model 500 includes multiple solution contexts 510, 530, and 550, which may be similar to the business contexts described above with respect to FIG. 1-4. Each of the solution contexts 510, 530, and 550 may be defined (e.g., indicated) within the solution model 500 by one or more solution descriptors (e.g., a word, phrase, string, number, or code that describes an aspect, a characteristic, or an attribute of a solution or its solution context). Accordingly, one or more of the solution contexts 510, 530, and 550 may be defined by a portion (e.g., a second portion) of the solution descriptors in the solution model 500 (e.g., a subset of the solution descriptors in the solution model 500).

Moreover, one or more of the solution contexts 510, 530, and 550 may be standardized, hierarchical, or both. In various example embodiments, the solution model 500 is standardized, hierarchical, or both. In some example embodiments, the solution descriptors are arranged as multiple branches of the solution model 500, where each solution context is defined by one of the multiple branches, and each of the multiple branches is defined by a portion (e.g., a unique subset) of the solution descriptors in the solution model 500.

The solution context 510 may include the solution descriptors 511-526 which define (e.g., indicate) the solution contexts 510 within the solution model 500. In other words, the solution context 510 may be defined (e.g., in its entirety) by the solution descriptors 511-526. In some example embodiments, the solution context 510 is defined by the solution descriptors 511-517, while in certain example embodiments, the solution context 110 is defined by the solution descriptors 511-526. The solution descriptors 511-526 may be arranged (e.g., represented) hierarchically as shown in FIG. 5.

The solution descriptor 511 may represent an industry sector (e.g., “consumer packaged goods (CPG)”) and may be arranged as being superior to (e.g., inclusive of or more general than) the solution descriptor 512. The solution descriptor 512 may represent a value system (e.g., “CPG-Food”) and may be arranged as being superior to the solution descriptor 513. The solution descriptor 513 may represent a value chain (e.g., “CPG-Food-Meat” or “CPG-Food-Dairy”) and may be arranged as being superior to the solution descriptor 514. The solution descriptor 514 may represent a business domain (e.g., “Customer”) and may be arranged as being superior to the solution descriptor 515. The solution descriptor 515 may represent a value stream (e.g., “Order-to-Cash”) and may be arranged as being superior to the solution descriptor 516. The solution descriptor 516 may represent a process (e.g., “Sales Order Process”) and may be arranged as being superior to the solution descriptor 517. The process represented by the solution descriptor 516 may be a business process with respect to the business model 100. The solution descriptor 717 may represent a solution to an activity (e.g., “Create Sales Order”). The activity addressed by the solution descriptor 517 may be a business activity (e.g., a business function or business transaction) with respect to the business model 100. According to various example embodiments, a solution to an activity may include or involve the performance (e.g., suggested, requested, instructed, or executed) of one or more transactions. A transaction within a solution may include or involve usage of one or more screens (e.g., windows within a graphical user interface) displayable by a business management system. A screen used for a transaction within the solution may include or involve one or more fields (e.g., data entry fields or data display fields) presentable by the business management system.

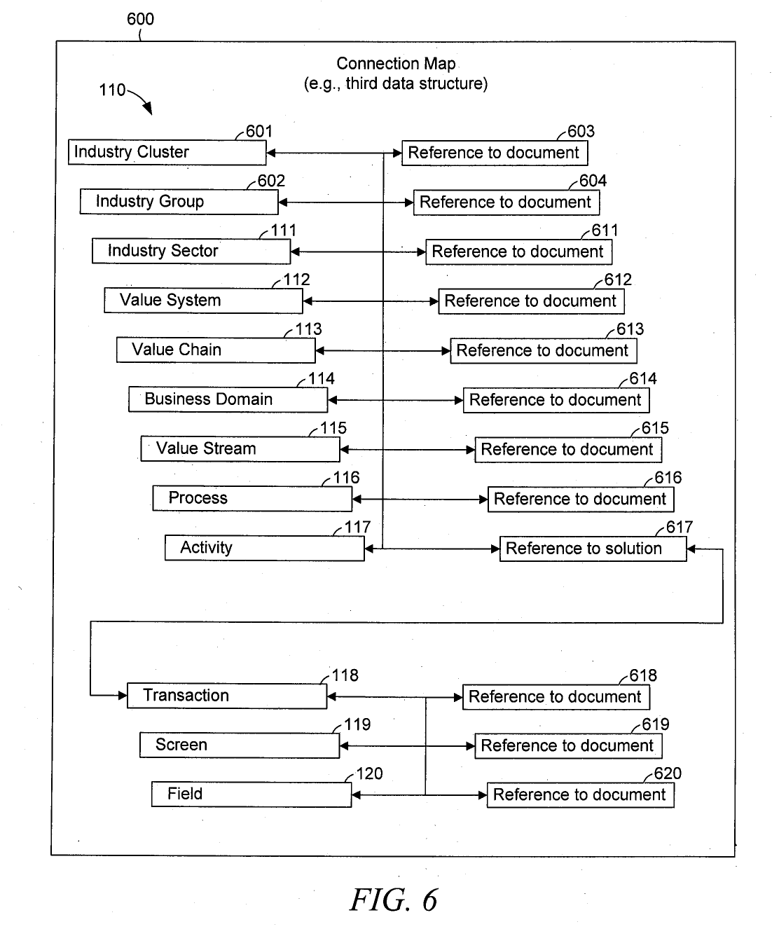

FIG. 6 is a conceptual diagram illustrating a connection map 600, which is represented as a data structure (e.g., a third data structure) of correspondences between references and descriptors (e.g., context descriptors) of the business model 100, according to some example embodiments. The references may be references to solutions for activities or references to information (e.g., documents) pertinent to corresponding activities or their business contexts. In various example embodiments, the connection map 600 defines (e.g., indicates) correspondence relationships between one or more of the context descriptors of the business model 100 and one or more references to solutions or documents. According to certain example embodiments, the connection map 600 includes correspondences between references and descriptors (e.g., transaction descriptors, screen descriptors, and field descriptors) that describe all or part of a solution (e.g., a business solution) to an activity (e.g., a business activity) supported by a business management system. FIG. 6 illustrates correspondence relationships with arrows (e.g., between context descriptors and references).

Although the connection map 600 may store correspondence information regarding any number of business contexts (e.g., business contexts 110, 130, and 150), FIG. 6 shows correspondences for the business context 110. In some example embodiments, context descriptors 601 and 602 may be used to define (e.g., partially define) the business context 110. Accordingly, the business context 110 may include one or both of the context descriptors 601 and 602. The context descriptor 601 may represent an industry cluster (e.g., “Manufacturing”) and may be arranged superior to the context descriptors 602. The context descriptor 602 may represent an industry group (e.g., “Process Industries”) and may be arranged superior to one or more of the context descriptors 111-117, which are discussed above with respect to FIG. 1 and FIG. 2.

As shown in FIG. 6, the context descriptor 601 has a correspondence relationship (e.g., is correlated) with the reference 603 to a document. This document may be pertinent to the business context 110. More specifically, this document may reference the industry cluster represented by the context descriptors 601 (e.g., “Manufacturing”). In particular, this document may contain information (e.g., background, best practices, strategic business plans, or specific instructions) regarding the industry cluster. According to various example embodiments, additional correspondence relationships may be defined in the connection map 600, as shown in FIG. 6 by the arrows.

The context descriptor 602 has a correspondence relationship with the reference 604 to a document (e.g., a different document from what is described above). This document may be pertinent to the business context 110. More specifically, this document may reference the industry group represented by the context descriptors 602 (e.g., “Process Industries”). In particular, this document may contain information (e.g., background, best practices, strategic business plans, or specific instructions) regarding the industry group. According to various example embodiments, additional correspondence relationships may be defined in the connection map 600, as shown in FIG. 6 by the arrows.

The context descriptor 111 has a correspondence relationship with the reference 611 to a document (e.g., a different document from what is described above). This document may be pertinent to the business context 110. More specifically, this document may reference the industry sector represented by the context descriptor 111 (e.g., “consumer packaged goods (CPG)”). In particular, this document may contain information (e.g., background, best practices, strategic business plans, or specific instructions) regarding the industry sector. According to various example embodiments, additional correspondence relationships may be defined in the connection map 600, as shown in FIG. 6 by the arrows.

The context descriptor 112 has a correspondence relationship with the reference 612 to a document (e.g., a different document from what is described above). This document may be pertinent to the business context 110. More specifically, this document may reference the value system represented by the context descriptor 112 (e.g., “CPG-Food”). In particular, this document may contain information (e.g., background, best practices, strategic business plans, or specific instructions) regarding the value system. According to various example embodiments, additional correspondence relationships may be defined in the connection map 600, as shown in FIG. 6 by the arrows.

The context descriptor 113 has a correspondence relationship with the reference 613 to a document (e.g., a different document from what is described above). This document may be pertinent to the business context 110. More specifically, this document may reference the value chain represented by the context descriptor 113 (e.g., “CPG-Food-Meat”). In particular, this document may contain information (e.g., background, best practices, strategic business plans, or specific instructions) regarding the value chain. According to various example embodiments, additional correspondence relationships may be defined in the connection map 600, as shown in FIG. 6 by the arrows.

The context descriptor 114 has a correspondence relationship with the reference 614 to a document (e.g., a different document from what is described above). This document may be pertinent to the business context 110. More specifically, this document may reference the business domain represented by the context descriptor 114 (e.g., “Customer”). In particular, this document may contain information (e.g., background, best practices, strategic business plans, or specific instructions) regarding the business domain. According to various example embodiments, additional correspondence relationships may be defined in the connection map 600, as shown in FIG. 6 by the arrows.

The context descriptor 115 has a correspondence relationship with the reference 615 to a document (e.g., a different document from what is described above). This document may be pertinent to the business context 110. More specifically, this document may reference the value stream represented by the context descriptor 115 (e.g., “Order-to-Cash”). In particular, this document may contain information (e.g., background, best practices, strategic business plans, or specific instructions) regarding the value stream. According to various example embodiments, additional correspondence relationships may be defined in the connection map 600, as shown in FIG. 6 by the arrows.

The context descriptor 116 has a correspondence relationship with the reference 616 to a document (e.g., a different document from what is described above). This document may be pertinent to the business context 110. More specifically, this document may reference the process represented by the context descriptor 116 (e.g., “Sales Order Process”). In particular, this document may contain information (e.g., background, best practices, strategic business plans, or specific instructions) regarding the process. According to various example embodiments, this document describes an instruction regarding execution of the process, a reason to execute the process, a consequence of execution of the process, or any suitable combination thereof. According to various example embodiments, additional correspondence relationships may be defined in the connection map 600, as shown in FIG. 6 by the arrows.

The context descriptor 117 has a correspondence relationship with the reference 617 to a solution (e.g., a solution to the corresponding activity represented by the context descriptor 117). In some example embodiments, the reference 617 to the solution refers to (e.g., by inclusion or by pointer) the solution descriptor 517. In certain example embodiments, the reference 617 is the same as, or a copy of, the solution descriptor 517. In various example embodiments, the solution is described in a document (e.g., a different document from what is described above). This document may be pertinent to the business context 110. More specifically, this document may reference the activity represented by the context descriptor 117 (e.g., “Create Sales Order”). In particular, this document may contain information (e.g., background, best practices, strategic business plans, or specific instructions) regarding the activity. According to various example embodiments, this document describes an instruction regarding performance of the activity, a reason to perform the activity, a consequence of performance of the activity, or any suitable combination thereof. Although, in general, a reference may correspond to a solution or a document pertinent to (e.g., referencing or describing) that solution, for clarity, FIG. 6 depicts the context descriptors 111-116 as corresponding to the references 611-616 to documents, while the context descriptor 117 is shown as corresponding to the reference 617 to a solution. Additional correspondence relationships may be defined in the connection map 600, as shown in FIG. 6 by the arrows.

According to various example embodiments, the context descriptor 117, the reference 617 to the solution, or both, has a correspondence relationship with a transaction represented by a transaction descriptor 118. The transaction descriptor 118 may represent a transaction (e.g., “Purchase Order Creation” or “Enter the Terms of the Order”) included in the solution that corresponds to the reference 617. For example, the transaction may be one of multiple transactions suggested, requested, instructed, or executed as the solution to a business activity represented by the context descriptor 117. The transaction descriptor 118 has a correspondence relationship with a reference 618 to a document (e.g., a different document from what is described above). This document may be pertinent to (e.g., descriptive of) the transaction represented by the transaction descriptor 118. More specifically, this document may reference the transaction represented by the transaction descriptor 118. In particular, this document may contain information (e.g., background, best practices, strategic business plans, or specific instructions) for performing the transaction. Additional correspondence relationships may be defined in the connection map 600, as shown in FIG. 6 by the arrows.

According to certain example embodiments, the context descriptor 117, the reference 617 to the solution, the transaction descriptor 118, or any suitable combination thereof, has a correspondence relationship with a screen (e.g., a window within a graphical user interface) represented by a screen descriptor 119. The screen descriptor 119 may represent a screen (e.g., a “Vendor Details Entry” screen or an “Item Details Entry” screen) that is used or usable in the solution that corresponds to the reference 617. For example, the screen may be one of multiple screens suggested, requested, instructed, or used in processing or performing the transaction represented by the transaction descriptor 118. The screen descriptor 119 has a correspondence relationship with a reference 619 to a document (e.g., a different document from what is described above). This document may be pertinent to the screen represented by the screen descriptor 119. More specifically, this document may reference the screen represented by the screen descriptor 119. In particular, this document may contain information (e.g., background, best practices, strategic business plans, or specific instructions) for using the screen. Additional correspondence relationships may be defined in the connection map 600, as shown in FIG. 6 by the arrows.

According to some example embodiments, the context descriptor 117, the reference 617 to the solution, the transaction descriptor 118, the screen descriptor 119, or any suitable combination thereof, has a correspondence relationship with a field (e.g., a data entry field or a data display field within window of a graphical user interface) represented by a field descriptor 120. The field descriptor 120 may represent a field (e.g., a “Contract Number” field or an “Item Price” field) that is used or usable in the solution that corresponds to the reference 617. For example, the field may be one of multiple fields suggested, requested, instructed, or used in the screen represented by the screen descriptor 119. The field descriptor 120 has a correspondence relationship with a reference 620 to a document (e.g., a different document from what is described above). This document may be pertinent to the field represented by the field descriptor 120. More specifically, this document may reference the field represented by the field descriptor 120. In particular, this document may contain information (e.g., background, best practices, strategic business plans, or specific instructions) for using the field. Additional correspondence relationships may be defined in the connection map 600, as shown in FIG. 6 by the arrows.

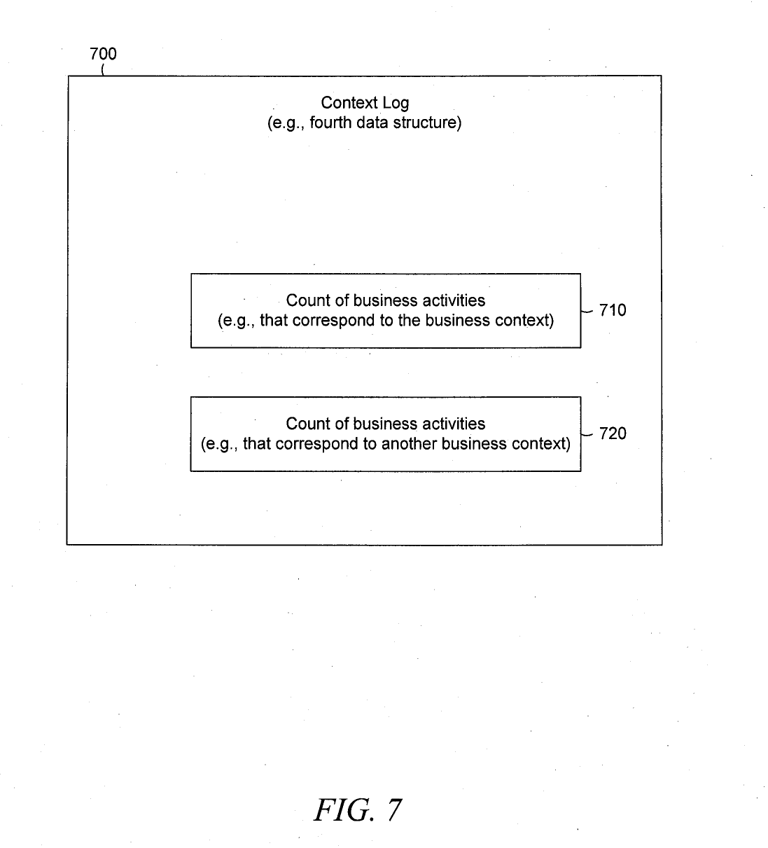

FIG. 7 is a conceptual diagram illustrating a context log 700, which is represented as a data structure (e.g., a fourth data structure) storing counts of one or more business activities (e.g., the activity represented by the context descriptor 117) correlated with one or more business contexts (e.g., business context 110), according to some example embodiments. Shown in FIG. 7 are counts 710 and 720 of business activities. The count 710 may represent a number of times that one or more business activities which correspond to the business context 110 have been initiated, performed, or executed using the business management system. The count 720 may represent a number of times that a particular business activity (e.g., the activity represented by the context descriptor 137) has been initiated, performed, or executed using the business management system. In some example embodiments, one or more of the counts 710 and 720 correspond to a particular user of the business management system (e.g., as identified by a user name, password, or any suitable combination thereof). In certain example embodiments, one or more of the counts 710 and 720 correspond to a particular user role within the business management system (e.g., the user role represented by the context descriptor 126). In various example embodiments, one or more of the counts 710 and 720 correspond to a particular user department within the business management system (e.g., the user department represented by the context descriptor 125). Similarly, one or more of the counts 710 and 720 may correspond to any one or more of the context descriptors supported by the business management system (e.g., context descriptors 111-157 and context descriptors 601 and 602). According to some example embodiments, the context log 700 allows a business management machine within the business management system to track the business contexts that are correlated with business activities engaged by users.

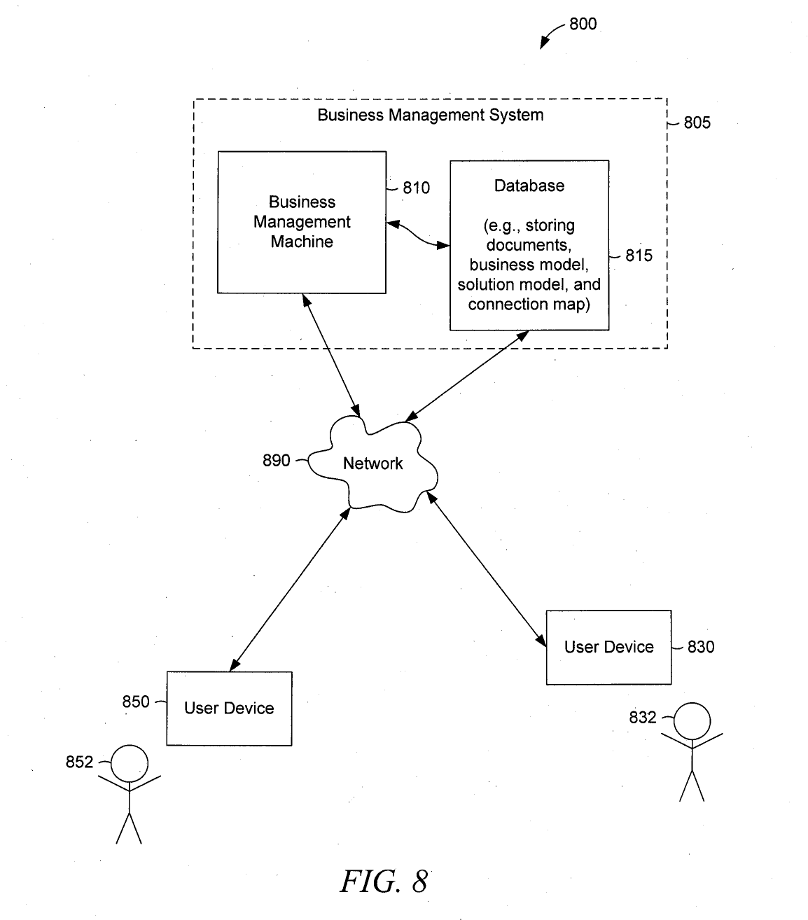

FIG. 8 is a network diagram illustrating a network environment 800 suitable for connecting the business context 110 to a business solution (e.g., the business solution corresponding to the reference 617), according to some example embodiments. The accessing of the business context 110 may be based on detection of the business activity represented by the context descriptor 117, according to various example embodiments.

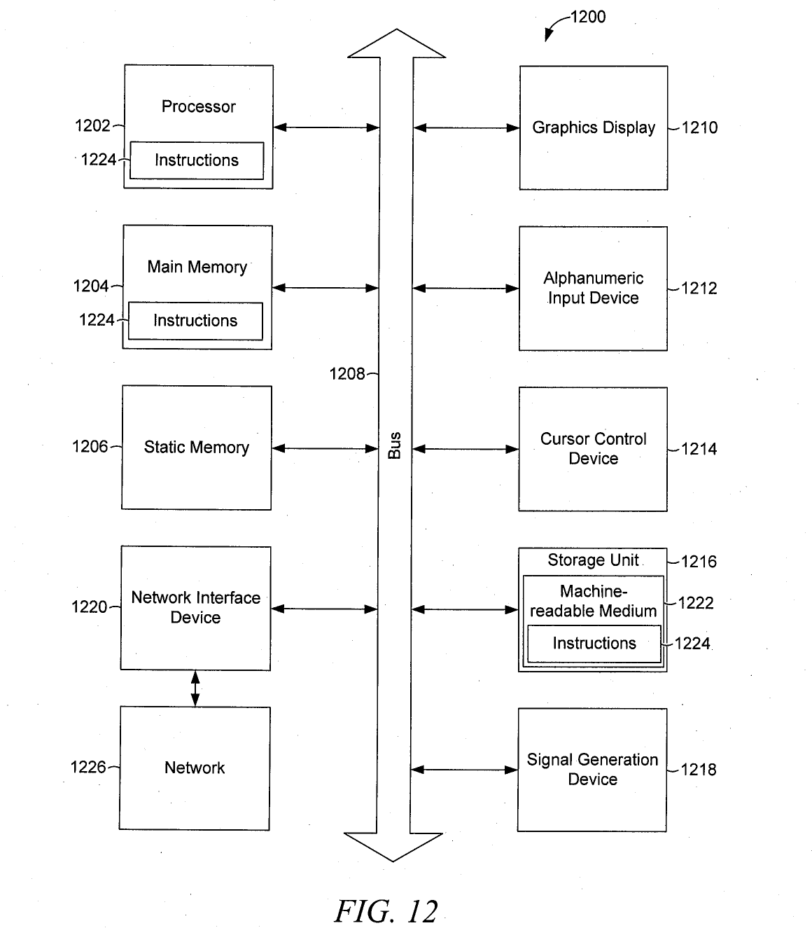

The network environment 800 includes a business management machine 810, a database 815, and user devices 830 and 850, all communicatively coupled to each other via a network 890. In some example embodiments, the business management machine 810 and the database 815 form all or part of a business management system 805. The business management machine 810, the database 815, and the user devices 830 and 850 may each be implemented in a computer system, in whole or in part, as described below with respect to FIG. 12.

The business management system 805 is configured to facilitate (e.g., process or perform) all or part of one or more business activities (e.g., by implementing one or more software modules configured to processor perform all or part of the one or more business activities). The business management machine 810 may be configured to facilitate all or part of any one or more of these business activities (e.g., by implementing one or more of the software modules). In some example embodiments, multiple instances of the business management machine 810 may be included in the business management system 805. The database 815 is a data repository (e.g., an information storage device) that stores information pertinent to the business management machine 810, the business management system 805, or any suitable combination thereof. As shown, the database 815 may be connected to the business management machine 810 within the business management system 805. In some example embodiments, the database 815 may be connected to the business management machine 810 by the network 890.

Also shown in FIG. 8 are users 832 and 852. One or both of the users 832 and 852 may be a human user (e.g., a human being), a machine user (e.g., a computer configured by a software program to interact with the user device 830), or any suitable combination thereof (e.g., a human assisted by a machine or a machine supervised by a human). The user 832 is not part of the network environment 800, but is associated with the user device 830 and may be a user of the user device 830. For example, the user device 830 may be a desktop computer, a vehicle computer, a tablet computer, a navigational device, a portable media device, or a smart phone belonging to the user 832. Likewise, the user 852 is not part of the network environment 800, but is associated with the user device 850. As an example, the user device 850 may be a desktop computer, a vehicle computer, a tablet computer, a navigational device, a portable media device, or a smart phone belonging to the user 852.

Any of the machines, databases, or devices shown in FIG. 8 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines illustrated in FIG. 8 may be combined into a single machine, and the functions described herein for any single machine may be subdivided among multiple machines.

The network 890 may be any network that enables communication between machines (e.g., business management machine 810 and the user device 830). Accordingly, the network 890 may be a wired network, a wireless network (e.g., a mobile or cellular network), or any suitable combination thereof. The network 890 may include one or more portions that constitute a private network, a public network (e.g., the Internet), or any suitable combination thereof.

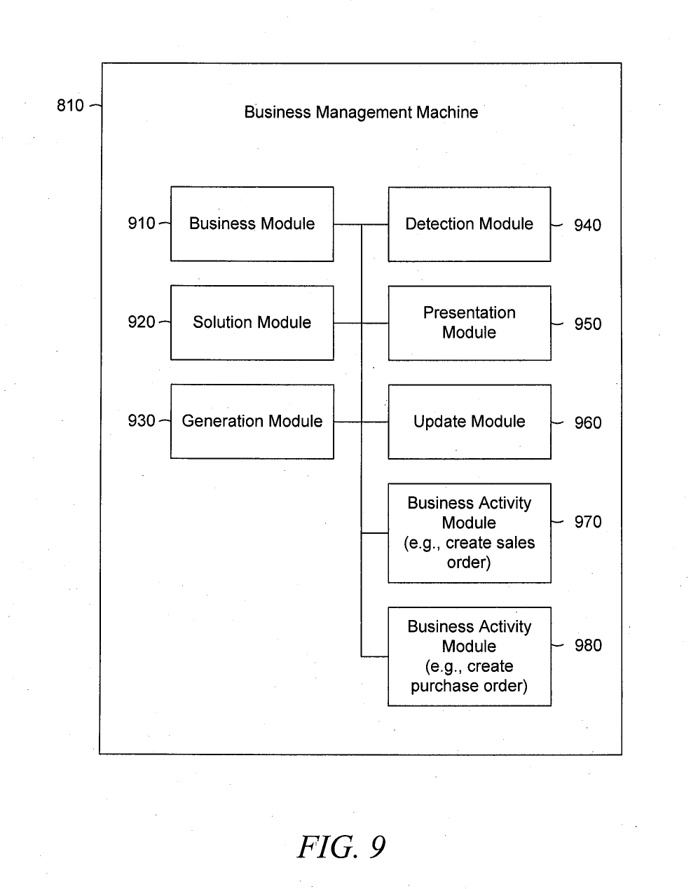

FIG. 9 is a block diagram illustrating components of the business management machine 810, according to some example embodiments. The business management machine 810 includes a business module 910, a solution module 920, a generation module 930, and a detection module 940. According to various example embodiments, the business management machine may include a presentation module 950, an update module 960, one or more business activity modules 970 and 980, or any suitable combination thereof. The modules of the business management machine 810, according to various example embodiments, may be configured to communicate with each other (e.g., via a bus, shared memory, or a switch). Any one or more of the modules described herein may be implemented using hardware (e.g., a processor of a machine) or a combination of hardware and software. Moreover, any two or more of these modules may be combined into a single module, and the functions described herein for a single module may be subdivided among multiple modules.

The business module 910 is configured to access the business model 100 (e.g., from the database 815). In other words, the business module 910 may access a first data structure that is representative of the business model 100, which is described above with respect to FIG. 1-4.

The solution module 920 is configured to access the solution module 500 (e.g., from the database 815). In other words, the solution module 920 may access a second data structure that is representative of the solution model 500, which is described above with respect to FIG. 5.

The generation module 930 is configured to generate the connection map 600 and store the connection map 600 (e.g., in the database 815). In other words, the generation module 930 may generate and store a third data structure that is representative of the connection map 600, which is described above with respect to FIG. 6.

The detection module 940 is configured to detect a business activity (e.g., the activity represented by the context descriptor 117) being engaged in by the user 832 of the business management system 805. The business activity may be correlated with the business context 110, which is defined by the portion (e.g., a first portion) of the context descriptors in the business model 100. In other words, the detection module 940 may detect the business activity in progress within the business management system 805, and the business activity may be correlated with the business context 110, which is defined by a subset (e.g., a first subset) of the context descriptors in the first data structure (e.g., accessed by the business module 910).

The presentation module 950 is configured to present a reference to a solution or a document (e.g., reference 617 to a solution pertinent to the activity represented by the context descriptor 117). The presenting of the reference may be based on (e.g., in response to) the detecting of the business activity by the detection module 940, based on an access of the connection map 600 generated by the generation module 930, or based on any suitable combination thereof.

The update module 960 is configured to update the context log 700. For example, the update module 960 may update a fourth data structure that stores the count 710 of business activities, which is described above with respect to FIG. 7. The updating of the context log 700 may be based on (e.g., in response to) the detecting of the business activity by the detection module 940, based on an access of the connection map 600, or based on any suitable combination thereof.

The business activity modules 970 and 980 may be configured to process (e.g., initiate, perform, or execute) respective business activities within the business management system 805. For example, the business activity module 970 may be a software module that, when implemented by the business management machine 110, configures the business management machine 110 to process the business activity represented by the context descriptor 117 (e.g., “Create Sales Order”). As another example, the business activity module 980 may be a software module that, when implemented by the business management machine 110, configures the business management machine 810 to process the business activity represented by the context descriptor 137 (e.g., “Create Purchase Order”). According to various example embodiments, any number of business activities may be supported by the business management machine 810 by inclusion of additional business activity modules.

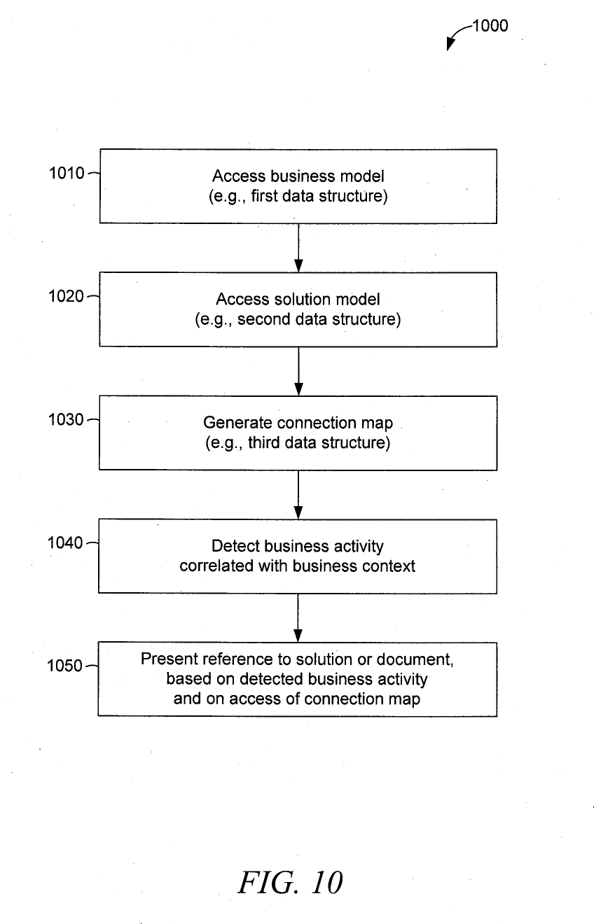

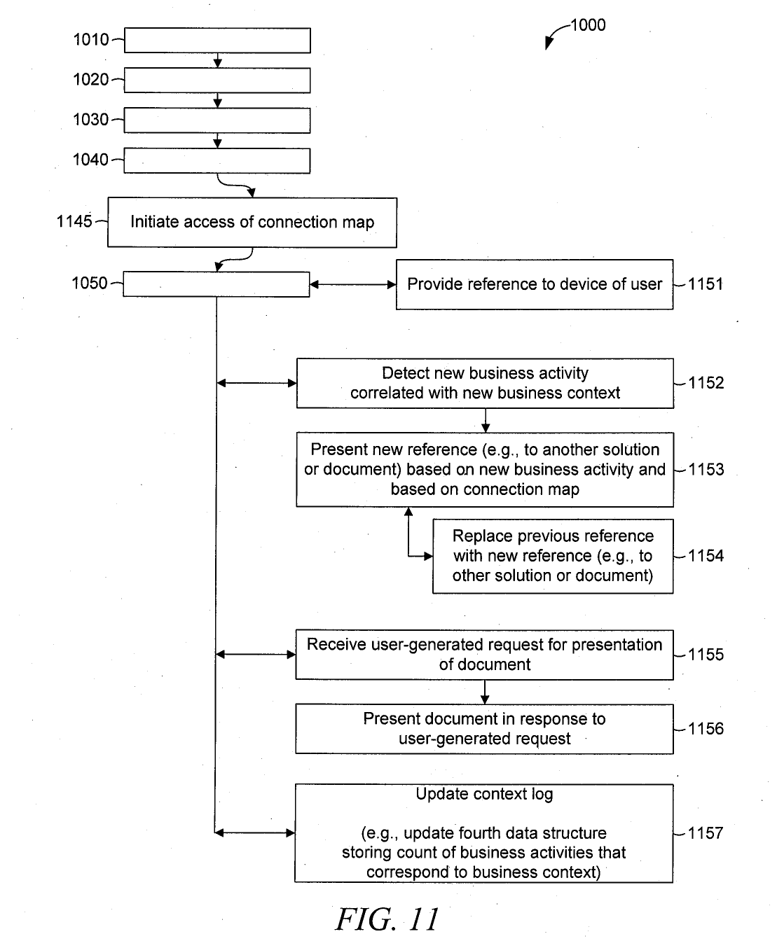

FIG. 10-11 are flowcharts illustrating operations of the business management machine 810 in performing a method 1000 of connecting the business context 110 to a business solution or a document pertinent thereto, based on (e.g., in response to) detection of the business activity represented by the context descriptor 117, according to some example embodiments. Similarly, the method 1000 may involve connection of the business context 130 to a business solution or a document descriptive thereof, based on detection of the business activity represented by the context descriptor 137. Likewise, the method 1000 may connect the business context 150 to a business solution or a corresponding document, based on detection of the business activity represented by the context descriptor 157. According to various example embodiments, the business context 110 may be accessed (e.g., from the business model 100) and connected to a business solution based on detection of any activity, function, transaction, or process that corresponds to a context descriptor within the business model 100.

Operations in the method 1000 may be performed by the business management machine 810, using modules described above with respect to FIG. 9. As shown in FIG. 10, the method 1000 may include operations 1010, 1020, 1030, 1040, and 1050.

In operation 1010, the business module 910 accesses the business model 100, which is described above with respect to FIG. 1-4. As noted above, the business model 100 may include business contexts 110, 130, and 150. Moreover, the business model 100 may be represented as a first data structure of context descriptors (e.g., context descriptors 111-126, context descriptors 131-137, context descriptors 151-157, and context descriptors 601 and 602) that are pertinent to the business management system 805. A portion (e.g., a first portion) of these context descriptors (e.g., context descriptors 111-126) may define or indicate the business context 110.

In operation 1020, the solution module 920 accesses the solution model 500, which is described above with respect to FIG. 5. As noted above, the solution model 500 may include solution contexts 510, 530, and 550. Moreover, the solution model 500 may be represented as a second data structure of solution descriptors (e.g., solution descriptors 511-517) that are pertinent to the business management system 805. A portion (e.g., a second portion) of the solution descriptors (e.g., solution descriptors 511-517) may define or indicate the solution context 510.

In operation 1030, the generation module 930 generates the connection map 600, which is described above with respect to FIG. 6. As noted above, the connection map 600 may be a third data structure that indicates a correspondence between a context descriptor (e.g., context descriptor 117) and a reference (e.g., referenced 617 to a solution or a document pertinent to the context descriptor or its business context. For example, the connection map 600 may indicate a correspondence between a document and the portion of the context descriptors (e.g., context descriptors 111-126) that identify the business context 110. As another example, the connection map 600 may indicate that the context descriptors 111-117 have a correspondence relationship to a solution or a document that is pertinent to the activity (e.g., business activity) represented by the context descriptor 117. This correspondence relationship may be indicated within the connection map 600 by the reference 617, which is described above with respect to FIG. 6. In some example embodiments, the generating of the connection map 600 is based on the solution or document referenced by the reference 617 being pertinent to the business context 110.

In operation 1040, the detection module 940 detects the business activity that is represented by the context descriptor 117 (e.g., creation of a sales order). For example, the detection module 940 may detect that the business activity is engaged (e.g., initiated, requested, or performed) by the user 832 of the business management system 805. As another example, the detection module 940 may detect that the business activity is in progress within the business management system 805. As noted above, the business activity is correlated with the business context 110, which is defined by a portion (e.g., first portion) of the context descriptors in the business model 100.

In operation 1050, the presentation module 950 presents the reference 617, which may refer to a solution that is pertinent to the activity represented by the context descriptor 117. In some example embodiments, the presentation module 950 presents the reference 617 as a reference to a document descriptive of the solution or any portion thereof (e.g., a transaction, a screen, or a field pertinent to the solution). For example, the reference 617 may be a title, a description, a link (e.g., a hyperlink), or any suitable combination thereof, with respect to a document that describes the solution for the activity represented by the context descriptor 117. Accordingly, the reference 617 may identify the document (e.g., for presentation to the user 832 via the user device 830). The presenting of the reference 617 may be based on the detecting of the business activity performed in operation 1040, on an access of the connection map 600 (e.g., generated in operation 1030), or on any suitable combination thereof. This access of the connection map 600 may be performed by the business module 910, as described below with respect to FIG. 11. Moreover, the access of the connection map 600 may access any one or more of the correspondence relationships described above with respect to FIG. 6. Accordingly, operation 1050 may be performed based on any one or more of the correspondence relationships described above with respect to FIG. 6. This may have the effect of enabling presentation of a reference likely to be most relevant to the business context 110 (e.g., specified by the context descriptor 117 representing an activity within the business context 110), as well as enabling presentation of additional references (e.g., to documents of greater or lesser scope).

As shown in FIG. 11, the method 1000 may include one or more of operations 1145 and 1151-1157. In operation 1145, the detection module 940 initiates an access of the connection map 600 generated in operation 1030. In some example embodiments, the detection module 940 causes the business module 910 to access the connection map 600 (e.g., from the database 815). In certain example embodiments, the detection module 940 causes the solution module 922 access the connection map 600 (e.g., from the database 815). In various example embodiments, the detection module 940 causes the presentation module 950 to perform the access of the connection map 600 (e.g., from the database 815). In response to operation 1145, the business management machine 810 accesses the connection map 600 (e.g., via the business module 910, the solution module 920, or the presentation module 950).

Operation 1151 may be performed as part (e.g., a precursor task, a subroutine, or a portion) of operation 1050, in which the presentation module 950 presents the reference 617. In operation 1151, the reference 617 is provided to the user device 830, which is described above with respect to FIG. 8. Operation 1151 may be performed in situations where the user 832 is engaged in the business activity represented by the context descriptor 117.

In some example embodiments, the business management machine 810 supports dynamic presentation (e.g., replacement) of references to solutions or documents, as the user 832 engages in various activities supported by the business management system 805. Accordingly, one or more of operations 1152-1154 may be performed subsequent to performance of operation 1050, in which the presentation module 950 presents the reference 617 (e.g., to the user 832 via the user device 830). In operation 1152, the detection module 940 detects another business activity (e.g., a new business activity or a further business activity). This business activity may be represented by the context descriptor 137 (e.g., “Create Purchase Order”). Hence, this business activity may be correlated with a further business context (e.g., business context 130) within the business model 100. Based on (e.g., in response to) the detection of this other business activity in operation 1152, operation 1153 may be performed by the presentation module 950.

In operation 1153, the presentation module 950 presents another reference (e.g., a new reference or a further reference) to another solution or document. This other solution or document may be pertinent to the business activity detected in operation 1152. For example, the detection module 940 may execute operation 1152 by detecting the business activity that is represented by the context descriptor 137 (e.g., “Create Purchase Order”), and based on (e.g., in response to) this detected business activity, the presentation module 950 may execute operation 1153 by presenting a reference to a document that is pertinent to (e.g., references) the business activity represented by the context descriptor 137. This may have the effect of presenting successive references (e.g., to successive documents) as various business activities are processed (e.g., initiated, started, or executed) by the business management system 805.

Operation 1154 may be performed as part (e.g., a precursor task, a subroutine, or a portion) of operation 1153. In operation 1154, the presentation module 950 replaces the reference 617 to the solution that corresponds to the activity represented by the context descriptor 117 with a reference (e.g., to a document, a solution, or both) that is pertinent to the business activity detected in operation 1152. As an example, the presentation module 950 may replace (e.g., within a graphical window of a user interface displayed using the user device 830) the reference 617 with a reference to a document that is pertinent to the business activity represented by the context descriptor 137. This may have the effect of updating a graphical user interface (e.g., presented to the user 832) to display a reference to the document most relevant to a business activity in progress.

In certain example embodiments, the business management machine 810 is configured to present a reference to a document in response to a request from the user 832 (e.g., via the user device 830). Accordingly, one or more of operations 745 and 746 may be performed subsequent to performance of operation 1050, in which the presentation module 950 presents the reference 617 (e.g., to the user 832 via the user device 830). In operation 1155, the presentation module 950 receives a user-generated request for presentation of a document that corresponds to the reference 617. For example, the presentation module 950 may receive the user-generated request in the form of a mouse click on the reference 617, as presented in a graphical user interface.

Based on (e.g., in response to) the receiving of the user-generated request in operation 1155, operation 1156 may be performed by the presentation module 950. In operation 1156, the presentation module 950 presents the document that corresponds to the reference 617 (e.g., via the user device 830). For example, the presentation module 950 may retrieve the document (e.g., from the database 815) and provide the document to the user device 830 (e.g., for presentation to the user 832). This may have the effect of providing information (e.g., the document) that is pertinent to the activity detected in operation 1040. More specifically, operation 1156 may provide a document that references the activity represented by the context descriptor 117 (e.g., “Create Sales Order”). In some example embodiments, operation 1156 may communicate information (e.g., background, best practices, strategic business plans, or specific instructions) regarding the activity. According to various example embodiments, the document presented in operation 1156 may describe an instruction regarding execution of the activity, a reason to execute the activity, a consequence of execution of the activity, or any suitable combination thereof.

In various example embodiments, the business management machine 810 supports tracking of one or more business contexts (e.g., business context 110) as users (e.g., users 832 and 852) engage in business activities supported by the business management system 805. Accordingly, operation 1157 may be performed subsequent to operation 1050, in which the presentation module 950 presents the reference 617. In some example embodiments, operation 1157 may be performed subsequent to operation 1040, in which the detection module 940 detects the business activity that is represented by the context descriptor 117 and that is correlated with the business context 110.

In operation 1157, the update module 960 updates the context log 700, which is described above with respect to FIG. 7. In other words, the update module 960 may update a fourth, data structure that stores the count of 610, which may be a count of instances of the business activity that corresponds to the business context 110. The updating of the context log 700 may be based on the detecting of the business activity being engaged in by the user 832, as performed in operation 1040. In some example embodiments, the updating of the context log 700 may be based on the presenting of the reference 617, as performed in operation 1050.

According to various example embodiments, one or more of the methodologies described herein may facilitate generation of a connection map as a data structure that indicates correspondences between groups of context descriptors and business solutions or documents that describe them, where each group of context descriptors identifies a business context supported by a business management system. Moreover, one or more of the methodologies described herein may facilitate an access of one or more business contexts based on detection of a corresponding business activity being engaged or in progress. Hence, one or more the methodologies described herein may facilitate presentation of one or more references to one or more solutions or documents that are relevant to business activities being engaged by users or otherwise in progress. This may have the effect of presenting references to relevant documents (e.g., the most relevant documents) with respect to business activities, as these business activities are engaged in by one or more users of the business management system.

When these effects are considered in aggregate, one or more of the methodologies described herein may obviate a need for certain efforts or resources that otherwise would be involved in generating a connection map, detecting business activities, and presenting solutions or documents that are relevant to those detected business activities. Efforts expended by a user in identifying the most relevant solutions and documents with respect to the business activity may be reduced by one or more of the methodologies described herein. Computing resources used by one or more machines, databases, or devices (e.g., within the network environment 800) may similarly be reduced. Examples of such computing resources include processor cycles, network traffic, memory usage, data storage capacity, power consumption, and cooling capacity.

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system and within which instructions 1224 (e.g., software) for causing the machine 1200 to perform any one or more of the methodologies discussed herein may be executed. In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a peer-to-peer (or distributed) network environment. The machine 1200 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include a collection of machines that individually or jointly execute the instructions 1224 to perform any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The machine 1200 may further include a graphics display 1210 (e.g., a plasma display panel (PDP), a light emitting diode (LED) display, a liquid crystal display (LCD), a projector, or a cathode ray tube (CRT)). The machine 1200 may also include an alphanumeric input device 1212 (e.g., a keyboard), a cursor control device 1214 (e.g., a mouse, a touchpad, a trackball, a joystick, a motion sensor, or other pointing instrument), a storage unit 1216, a signal generation device 1218 (e.g., a speaker), and a network interface device 1220.

The storage unit 1216 includes a machine-readable medium 1222 on which is stored the instructions 1224 (e.g., software) embodying any one or more of the methodologies or functions described herein. The instructions 1224 may also reside, completely or at least partially, within the main memory 1204, within the processor 1202 (e.g., within the processor's cache memory), or both, during execution thereof by the machine 1200. Accordingly, the main memory 1204 and the processor 1202 may be considered as machine-readable media. The instructions 1224 may be transmitted or received over a network 1226 (e.g., network 890) via the network interface device 1220.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1200), such that the instructions, when executed by one or more processors of the machine (e.g., processor 1202), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a first data structure of context descriptors pertinent to a business management system,
a first portion of the context descriptors defining a business context among a plurality of business contexts;
accessing a second data structure of solution descriptors pertinent to the business management system,
a second portion of the solution descriptors defining a business solution among a plurality of business solutions;
generating a connection map as a third data structure that indicates a correspondence between business context and the business solution,
the generating of the connection map being performed by a processor of a machine;
detecting a business activity that is engaged in by a user of the business management system and correlated with the business context defined by the first portion of the context descriptors in the first data structure; and
presenting a reference to a document pertinent to the business solution in response to the detecting of the business activity correlated with the business context and in response to an access of the generated connection map that indicates the correspondence between the business context and the business solution.

2. The method of claim 1, wherein:
the first data structure includes a hierarchical arrangement of the context descriptors arranged as multiple branches of a business model,
a branch among the multiple branches including the first portion of context descriptors that defines the business context.

3. The method of claim 1, wherein:
the first data structure represents a business model that includes the plurality of business contexts, the business model being standardized and conforming to a standard;
the second data structure represents a solution model that includes the plurality of business solutions; and
the first portion of the context descriptors corresponds to the second portion of the solution descriptors within the connection map.

4. The method of claim 1, wherein:
the presenting of the reference includes providing the reference to a device of the user of the business management system.

5. The method of claim 1 further comprising:
detecting a further business activity engaged in by the user of the business management system and correlated with the further business context defined in the first data structure; and
presenting a further reference to a further document in response to the detecting of the further business activity correlated with the further business context.

6. The method of claim 5, wherein:
the presenting of the further reference to the further document includes replacing the reference to the document with the further reference to the further document within a graphical window presented to the user of the business management system.

7. The method of claim 1 further comprising:
initiating the access of the generated connection map in response to the detecting of the business activity.

8. The method of claim 1 further comprising:
receiving a user-generated request for presentation of the document based on the presented reference to the document; and
presenting the document in response to the user-generated request for the presentation of the document.

9. The method of claim 1 further comprising:
updating a context log by updating a third data structure that stores a count of business activities that correspond to the business context,
the updating of the context log being based on the detecting of the business activity engaged by the user and correlated with the business context.

10. The method of claim 1, wherein:
the document is pertinent to the business context; and
the generating of the connection map is based on the document being pertinent to the business context.

11. The method of claim 1, wherein:
the document references the business activity correlated with the business context defined by the portion of the context descriptors in the first data structure.

12. The method of claim 1, wherein:
the document describes at least one of an instruction on performance of the business activity, a reason to perform the business activity, or a consequence of performance of the business activity.

13. The method of claim 1, wherein:
the business management system implements multiple software modules,
a software module among the multiple software modules corresponding to the business context and being configured to process the business activity.

14. A non-transitory machine-readable storage medium comprising instructions that, when executed by one or more processors of a machine, cause the machine to perform operations comprising:
accessing a first data structure of context descriptors pertinent to a business management system,
a first portion of the context descriptors defining a business context among a plurality of business contexts;
accessing a second data structure of solution descriptors pertinent to the business management system,
a second portion of the solution descriptors defining a business solution among a plurality of business solutions;
generating a connection map as a third data structure that indicates a correspondence between business context and the business solution,
the generating of the connection map being performed by the one or more processors of the machine;
detecting a business activity that is engaged in by a user of the business management system and correlated with the business context defined by the first portion of the context descriptors in the first data structure; and
presenting a reference to a document pertinent to the business solution in response to the detecting of the business activity correlated with the business context and in response to an access of the generated connection map that indicates the correspondence between the business context and the business solution.

15. A system comprising:
a business module configured to access a first data structure of context descriptors pertinent to a business management system,
a first portion of the context descriptors defining a business context among a plurality of business contexts;
a solution module configured to access a second data structure of solution descriptors pertinent to the business management system,
a second portion of the solution descriptors defining a business solution among a plurality of business solutions;
a processor configured by a generation module to generate a connection map as a third data structure that indicates a correspondence between business context and the business solution;
a detection module configured to detect a business activity that is engaged in by a user of the business management system and correlated with the business context defined by the first portion of the context descriptors in the first data structure; and
a presentation module configured to present a reference to a document pertinent to the business solution in response to the detecting of the business activity correlated with the business context and in response to an access of the generated connection map that indicates the correspondence between the business context and the business solution.

16. The system of claim 15, wherein:
the second data structure includes a hierarchical arrangement of the solution descriptors arranged as multiple branches of a solution model,
a branch among the multiple branches including the second portion of solution descriptors that defines the business solution.

17. The system of claim 15, wherein:
the presentation module is configured to provide the reference to a device of the user of the business management system.

18. The system of claim 15, wherein:
the detection module is configured to detect a further business activity engaged by the user of the business management system and correlated with the further business context defined in the first data structure; and
the presentation module is configured to present a further reference to a further document in response to the detecting of the further business activity correlated with the further business context.

19. The system of claim 18, wherein:
the presentation module is configured to replace the reference to the document with the further reference to the further document within a graphical window presented to the user of the business management system.

20. The system of claim 15 further comprising:
an update module configured to update a context log by updating a fourth data structure that stores a count of business activities that correspond to the business context,
the updating of the context log being based on the detecting of the business activity engaged by the user and correlated with the business context.
